(19) United States
(12) Patent Application Publication
(10) Pub. No.: US 2008/0079324 A1
(43) Pub. Date: Apr. 3, 2008

(54) Vehicular alternating current generator

(75) Inventor: Toshihisa Aoshima, Nagoya (JP)

Correspondence Address: OLIFF & BERRIDGE, PLC, P.O. BOX 320850, ALEXANDRIA, VA, 22320-4850, US

(73) Assignee: DENSO CORPORATION, KARIYA-CITY (JP)

(21) Appl. No.: 11/905,678

(22) Filed: Oct. 3, 2007

(30) Foreign Application Priority Data
Oct. 3, 2006 (JP) 2006-271556

(51) Int. Cl. H02K 5/22; H02K 11/04; H02K 9/06

(52) U.S. Cl. 310/63; 310/68 D; 310/88

(57) ABSTRACT

A vehicular alternating current generator includes a rectifying device equipped with a battery terminal and mounted to a rear frame, an insulating member mounted around the battery terminal, and a cooling air discharge window formed in the rear frame for discharging cooling air generated by a cooling fan fixed to a rotor of the generator. The insulating member has a pan-shaped portion formed at a position for mounting of a battery cable connectable to the battery terminal, a peripheral wall extending around the pan-shaped portion, and a drain hole having a first open end formed at a position meeting with the cooling air discharge window and a second open end formed at a position at least partially meeting with the pan-shaped portion.

### CROSS REFERENCE TO RELATED APPLICATION

The present application is based on and claims priority from Japanese Patent Application No. 2006-271556, filed Oct. 3, 2006, the content of which is incorporated herein by reference.

### BACKGROUND OF THE INVENTION

1. Field of the Invention

The present invention relates to a vehicular alternating current generator adapted to be installed in motor vehicles, trucks and the like.

2. Description of the Related Art

It is heretofore known in the vehicular alternating current generators that water staying on the pan-shaped portion of an insulating member provided on a battery terminal can cause an insulation failure or corrosion of the battery terminal. To prevent such stay of water, various measures have been taken. One example of such prior proposals is disclosed in Japanese Patent Laid-open Publication (JP-A) No. 6-335192 wherein a vehicular alternating current generator has a slit or small hole provided for drainage at the pan-shaped portion of an insulating member.

In the vehicular alternating current generator disclosed in JP-A 6-33519, water, which has entered the pan-shaped portion of the insulating member, is drained by gravity through the slit or small hole. In this instance, however, a problem may occur that due to surface tension of the entering water, the drainage does not take place, allowing the water to stay on the pan-shaped portion of the insulating member. This problem becomes significant if the pan-shaped portion of the battery terminal faces upward (in a direction opposite to the ground surface).

### SUMMARY OF THE INVENTION

It is accordingly an object of the present invention to provide a vehicular alternating current generator, which can surely prevent water from staying on the pan-shaped portion of an insulating member of the battery terminal.

To achieve the foregoing object, there is provided according to the present invention a vehicular alternating current generator, which comprises a rectifying device equipped with a battery terminal, an insulating member mounted around the battery terminal, and a frame to which the rectifying device is mounted, the frame having a cooling air discharge window for discharging cooling air produced by a cooling fan fixed to a rotor of the generator. The insulating member has a pan-shaped portion formed at a position for mounting of a battery cable connectable to the battery terminal, a peripheral wall extending around the pan-shaped portion, and a through-hole having a first open end formed at a position meeting with the cooling air discharge window and a second open end formed at a position at least partially meeting with the pan-shaped portion. The through-hole will be hereinafter referred to as “drain hole”.

With this arrangement, when the cooling air is discharged from the cooling air discharge window, a negative pressure is created in the vicinity of the first open end of the drain hole. Under the effect of the negative pressure, water, which has entered the pan-shaped portion of the insulating member, is positively drawn outside the insulating member through the drain hole. This makes it possible to prevent water from staying on the pan-shaped portion. Thus, the battery terminal is free from the problem of insulation failure or corrosion.

Preferably, the insulating member further has a projection located adjacent to the cooling air discharge window, the first open end of the drain hole is disposed in an adjacent area of the projection and located downstream of the cooling air discharge window. By thus providing the projection, the adjacent area of the projection, which is located downstream of the cooling air discharge window, is held under negative pressure according to the principle of an air ejector. This will ensure that the pan-shaped portion of the insulating member is completely free from the water-staying problem.

The drain hole is preferably disposed such that the first open end is located at the same level as or, at a lower level than, the second open end. This arrangement further promotes drainage of water from the pan-shaped portion of the insulating member.

### BRIEF DESCRIPTION OF THE DRAWINGS

FIG. 1 is an axial cross-sectional view of a vehicular alternating current generator according to an embodiment of the present invention;

FIG. 2 is a side view of an insulating member provided on a battery terminal; and

FIG. 3 is an enlarged cross-sectional view of a portion of the generator including the battery terminal and the insulating member.

### DETAILED DESCRIPTION OF THE PREFERRED EMBODIMENT

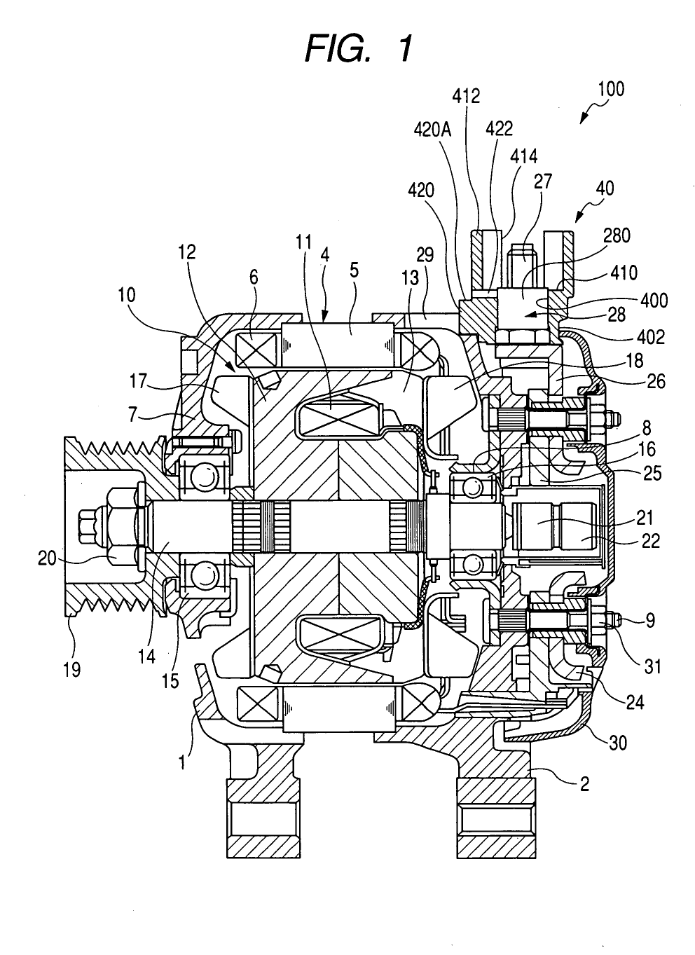

Referring now to the drawings and FIG. 1 in particular, there is shown in axial cross section a vehicular alternating current generator 100 according to one preferred embodiment of the present invention.

As shown in FIG. 1, the vehicular alternating current generator 100 generally comprises a front frame 1, a rear frame 2, a stator 4, a rotor 10, a rectifying device 24, and a rear cover 30.

The front frame 1 and the rear frame 2 have a bowl-shaped configuration and they are firmly connected together by a plurality of bolts with the stator 4 held between opposed open ends of the front and rear frames 1 and 2. The front frame 1 has a cylindrical bearing box 7 formed integrally therewith. The rear frame 2 has a bearing box 8 made of iron and attached to the rear frame 2 by means of a plurality of knurled bolts 9.

The stator 4 has a stator core 5 and a stator winding 6. The rotor 10 has a field winding 11, a pair of pole cores 12 and 13, and a rotary shaft 14. The rotor 10 is rotatably supported by a pair of bearing 15 and 16 firmly mounted in the bearing boxes 7 and 8, respectively. Centrifugal cooling fans 17, 18 are attached to axial end faces of the pole cores 12, 13. The front-side cooling fan 17 is of the mixed flow type having blades tilted in a rotating direction of the rotor 10 to produce streams of cooling air flowing toward the field winding 11. A pulley 19 is fixed by a nut 20 to a front end (left end in FIG. 1) of the rotary shaft 14 so that the rotary shaft 14 can be rotatably driven by an engine (not shown) of the vehicle. The rotary shaft 14 has a rear end located outside the rear frame 2, and a pair of slip rings 21 and 22 are provided on the rear end of the rotary shaft id and electrically connected to the field coil 11.

The rectifying device 24 is provided for rectifying three-phase AC (alternating-current) voltage output from the three-phase stator winding 6 to DC (direct-current) voltage. The rectifying device 24 includes a terminal base 25 having internally-provided wiring terminals, a positive-pole side heat-radiating fin 26, a negative-pole side heat-radiating fin (not shown), and a battery terminal 27 mounted to the positive-pole side heat-radiating fin 26 and connected to a battery (not shown). Each of the positive-pole side and negative-pole side heat-radiating fins supports thereon three rectifying elements (or six rectifying elements when two set of three-phase windings are provided). For mounting the battery terminal 27, the positive-pole side heat-radiating fin 26 has a through-hole formed at a portion thereof. The battery terminal 27 has a screw thread on its outer peripheral surface and is inserted in the through-hole of the positive-pole side heat-radiating fin 26 from one side thereof, and a nut 28 having a cylindrical top portion 280 is tightly fastened to the battery terminal 27 from the other side of the positive-pole side heat-radiating fin 26 to thereby secure the battery terminal 27 to the positive-pole side heat-radiating fin 26. In the illustrated embodiment, the positive-pole side heat-radiating fin 26 is disposed perpendicularly to the axis of the rotary shaft 14 in such a manner that only that portion of the positive-pole side heat-radiating fin 26, which includes the through-hole for mounting the battery terminal 27, is bent in a direction perpendicular to the remaining portion of the positive-pole side heat-radiating fin 26. With this arrangement, as shown in FIG. 1, the battery terminal 27 is disposed perpendicularly to the axis of the rotary shaft 14 (in a radial direction from the axis of the rotary shaft 14) with its tip end directed upward (in a direction opposite to the ground surface when the vehicular alternating current generator 100 is assembled in the vehicle). An insulating member 40 is provided around the battery terminal 27. A peripheral structure of the battery terminal 27 will be described later.

Electric components including the rectifying device 24, a voltage regulator and a brush unit (both not shown) are fixed to an outside axial end face of the rear frame 2 by a fastener means including the bolts 9. The rear cover 30 is a protective cover forming an outer shell member of synthetic resin (nylon, for example) and covers the electric components including the rectifying device 24 attached to an outer side of the rear frame 2. The rear cover 30 is fastened to the bolts 9 by means of nuts with the rectifying device 24 held between the rear frame 2 and the rear cover 30.

The vehicular alternating current generator 100 of the foregoing construction operates as follows. When a rotational torque of the engine is transmitted via a belt (not shown) to the pulley 19, the rotor 10 rotates in a predetermined direction. Then, an exciting voltage is applied to the field coil 11 of the rotor 10 whereupon respective pawl-shaped magnetic poles of the pole cores 12, 13 are magnetized to thereby cause the stator winding 6 to produce three-phase AC voltage. By the action of the rectifying device 24, a predetermined DC current (generated output) can be taken out from the battery terminal 27 mounted on the rectifying device 24. While the rotor 10 is rotating, the cooling fan 18 attached to the axial end face of the rear pole core 13 is also rotating. With this rotation of the cooling fan 18, the outside air is drawn from the cooling air intake window (not shown) formed in the rear cover 30 into an internal space of the rear cover 30, then circulates through the internal space of the rear cover 30 to thereby cool the electric components including the rectifying device 24, and finally is discharged from a cooling air discharge window 29 formed in the rear frame 2 at a position faced with an outer periphery of the cooling fan 18.

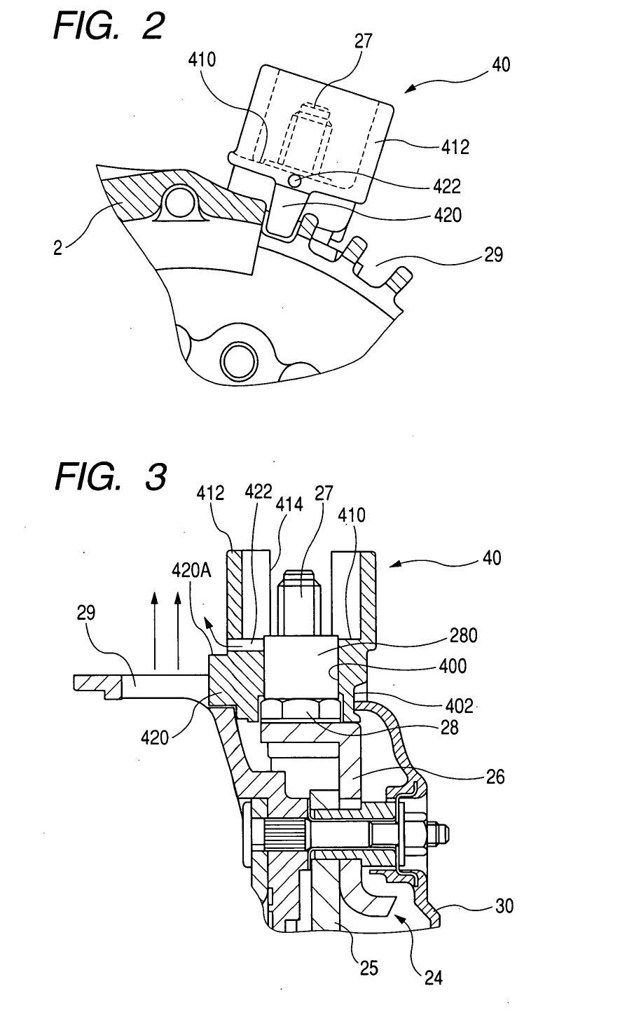

Next, the peripheral structure of the battery terminal 27 will be described with reference to FIGS. 1 to 3. As shown in FIGS. 1-3, the insulating member 40 has formed therein a central hole 400 and a peripheral groove 402. The insulating member 40 is assembled with the vehicular alternating current generator 100 such that the nut 28 used for setting the battery terminal 27 of the rectifying device 24 is inserted in the insulating member 40 with its cylindrical top portion 280 snugly received in the central hole 400 of the insulating member 40, and an outer edge of the rear cover 30 is engaged in the peripheral groove 402. The insulating member 40 has a pan-shaped portion 410 disposed around an upper end face of the cylindrical top portion 280 of the nut 28 fastened to the battery terminal 27, and a tubular peripheral wall 412 extending around the pan-shaped portion 410. The pan-shaped portion 410 is formed at a position provided for attachment of a battery cable (not shown) connectable to the battery terminal 27. The pan-shaped portion 410 is substantially flat. The peripheral wall 412 is partly cut out to form a cutout recess 414 (FIGS. 1 and 3), which is used to position the battery cable connectable to the battery terminal 28.

The insulating member 40 further has a radial projection 420 disposed adjacent to the cooling air discharge window 29 of the rear frame 2, and a through-hole (drain hole) 422 having a first open end disposed in an adjacent area 420A of the projection 420 and located downstream of the cooling air discharge window 29 when viewed in a flow direction of the cooling air. A second open end of the drain hole 422, which is opposite to the first end, is formed at a position located inside the peripheral wall 412 and at least partially meeting with the pan-shaped portion 410. In the illustrated embodiment, it is assumed that the vehicular alternating current generator 100 is installed in the vehicle in such a manner that the pan-shaped portion 410 is in a horizontal position (parallel to the ground surface). In this state of installation, the drain hole 422 is disposed to lie in a horizontal plane or inline at a slight angle to the horizontal such that first open end, which is adjacent to the projection 420, is located at a lower level than the second open end.

With the vehicular alternating current generator of the foregoing construction, it is possible to create a negative pressure in the vicinity of the first open end of the drain hole 422 when the cooling air is discharged from the cooling air discharge window 29. By virtue of the negative pressure thus created, water, which has entered the pan-shaped portion 410 of the insulating member 40, is positively drawn outside the insulating member 40 through the drain hole 422. This makes it possible to prevent water from staying on the pan-shaped portion 410 of the insulating member 40. Furthermore, by virtue of the radial projection 420 provided on the insulating member 40, the adjacent area 420A of the projection 410, which is disposed downstream of the cooling air discharge window 29, is positively held under negative pressure according to the principle of an air ejector. The pan-shaped portion 410 of the insulating member 40 is therefore completely free from the water-staying problem. Additionally, when the vehicular alternating current generator 100 is installed in the vehicle, the drain hole 422 is preferably disposed such that the first open end disposed adjacent to the cooling air discharge window 29 is located at a lower level than the second open end. This arrangement further promotes drainage of water from the pan-shaped portion 410 of the insulating member 40.

Obviously, various minor changes and modifications are possible in the light of the above teaching. It is to be understood that within the scope of the appended claims the present invention may be practiced otherwise than as specifically described.

What is claimed is:

1. A vehicular alternating current generator comprising:
a rectifying device equipped with a battery terminal;
an insulating member mounted around the battery terminal; and
a frame to which the rectifying device is mounted, the frame having a cooling air discharge window for discharging cooling air produced by a cooling fan fixed to a rotor of the generator,
wherein the insulating member has a pan-shaped portion formed at a position for mounting of a battery cable connectable to the battery terminal, a peripheral wall extending around the pan-shaped portion, and a through-hole having a first open end formed at a position meeting with the cooling air discharge window and a second open end formed at a position at least partially meeting with the pan-shaped portion.

2. A vehicular alternating current generator according to claim 1, wherein the insulating member further has a projection located adjacent to the cooling air discharge window, the first open end of the through-hole is disposed in an adjacent area of the projection and located downstream of the cooling air discharge window.

3. A vehicular alternating current generator according to claim 1, wherein the though-hole is disposed such that the first open end is located at the same level as or, at a lower level than, the second open end, when the generator is installed in the vehicle.
